(19) United States
(12) Patent Application Publication
(10) Pub. No.: US 2026/0351945 A1
(43) Pub. Date: Nov. 5, 2026

(54) WIRING HARNESS-ACCOMMODATING ARTICULATED ARM ASSEMBLY AND HEIGHT-ADJUSTABLE DESK

(71) Applicant: UE Furniture Co., Ltd, Huzhou (CN)

(72) Inventors: Minghua JIN, Huzhou (CN); Yebing WANG, Huzhou (CN); Xujing PI, Huzhou (CN)

(73) Assignee: UE Furniture Co., Ltd, Huzhou (CN)

(21) Appl. No.: 19/706,549

(22) Filed: Jun. 12, 2026

(30) Foreign Application Priority Data
Nov. 6, 2025 (CN) 202522358041.4

(51) Int. Cl. H02G 11/00; F16M 13/02

(52) U.S. Cl. CPC H02G 11/00; F16M 13/022

(57) ABSTRACT

A wiring harness-accommodating articulated arm assembly includes first and second movable arms and a linkage arm, a first limiting structure is disposed on the linkage arm, such that rotating points of the first and second movable arms are separated, and a clamping region among the first and second movable arms and the linkage arm is never closed for folding of the first and second movable arms, thereby effectively preventing hand pinching. In another articulated arm assembly, the linkage arm is replaced by a chain joint. A height-adjustable desk includes a desktop panel, a lifting column, a base, and the articulated arm assembly, the articulated arm assembly is connected to the desktop panel and the base; and when the lifting column moves, it drives the desktop panel to move up and down, and the articulated arm assembly folds or unfolds accordingly.

### CROSS-REFERENCE TO RELATED APPLICATIONS

This application claims priority to Chinese Patent Application No. 202522358041.4 with a filing date of Nov. 6, 2025. The content of the aforementioned application, including any intervening amendments thereto, is incorporated herein by reference.

### TECHNICAL FIELD

The present disclosure relates to the field of furniture, and in particular, to a wiring harness-accommodating articulated arm assembly and a height-adjustable desk.

### BACKGROUND

For existing common office desks, their desktop panels are generally non-adjustable in height. In spite of simple structures and higher stability, such desks offer inadequate comfort and flexibility for users with different statures, and cannot support standing office work. Hence, novel office desks with movable desktop panels have emerged on the market.

However, this brings a new problem. Fixed-length wiring harnesses of various electrical appliances can satisfy the use requirements of original desks. For the novel office desks, the wiring harnesses must be reserved with a sufficient extra length, ensuring that when the electrical appliances such as computers and desk lamps are moved to relatively high positions with the desktop panels, the wiring harnesses are not pulled or tensioned.

In view of this, to prevent the excessively long wiring harnesses from drooping onto the ground and causing tripping hazards when the desktop panels are located at relatively low positions, a wiring harness storage tool is required, and an articulated arm assembly is thus provided. The articulated arm assembly includes hollow tubes that are respectively hinged to the desktop panel and the base of the height-adjustable desk. As the desktop panel moves up and down, the articulated arm assembly unfolds or folds. The wiring harness is disposed in the hollow tubes for concealment and protection, thereby preventing the wiring harness from being exposed to droop onto the ground or cause the tripping hazards.

Nevertheless, the two hollow tubes of the articulated arm assembly are typically connected via a single hinge point. During folding, a spacing between the two hollow tubes at the hinge point decreases quickly, and the two hollow tubes are even attached, which is likely to cause hand pinching. The user's hands, feet or even trousers at the hinge point will be pinched by the two hollow tubes to cause injury or damage. This is more dangerous for short-statured children.

Therefore, there is an urgent need to provide an articulated arm assembly that can avoid the hand pinching.

### SUMMARY OF PRESENT INVENTION

To address the above technical problems, the present disclosure provides a wiring harness-accommodating articulated arm assembly, including first and second movable arms and a linkage arm. A first limiting structure is disposed on the linkage arm, such that rotating points of the first and second movable arms are separated, and a clamping region among the first and second movable arms and the linkage arm is never closed due to folding of the first and second movable arms, thereby effectively avoiding hand pinching.

The present disclosure provides another wiring harness-accommodating articulated arm assembly. The linkage arm is replaced by a chain joint. Actually, a plurality of linkage arms are connected and then connected to the first and second movable arms, which can achieve the same effect.

The present disclosure further provides a height-adjustable desk, including a desktop panel, a lifting column, a base, and the above articulated arm assembly. The articulated arm assembly is connected to the desktop panel and the base. When the lifting column moves, it drives the desktop panel to move up and down, and the articulated arm assembly folds or unfolds accordingly. This adapts to a lifting motion of the height-adjustable desk, protects the wiring harness, and avoids the hand pinching.

The technical solutions of the present disclosure are implemented as follows.

A wiring harness-accommodating articulated arm assembly includes a first movable arm, where the first movable arm is rotatably connected to a linkage arm; the linkage arm is rotatably connected to a second movable arm; the first movable arm and the second movable arm are respectively rotatably connected to different positions of the linkage arm; an included angle is formed between the first movable arm and the second movable arm; when the first movable arm and the second movable arm move, the included angle between the first movable arm and the second movable arm changes; a clamping region is formed among the first movable arm, the linkage arm and the second movable arm, and at a position close to the linkage arm; a side of the linkage arm facing toward the clamping region is provided with a first limiting structure; and the first limiting structure is configured such that when the first movable arm and the second movable arm rotate toward each other, a spacing between the first movable arm and the second movable arm in the clamping region is always greater than zero.

The present disclosure further provides a height-adjustable desk, including a lifting column, a desktop panel, a base, and the above articulated arm assembly, where the desktop panel is disposed on an upper end of the lifting column; the base is disposed on the lifting column and located below the desktop panel; the lifting column drives the desktop panel to move up and down relative to the base during extension and retraction; the two movable arms of the articulated arm assembly are respectively rotatably connected to the desktop panel and the base; when the desktop panel moves up relative to the base, the two movable arms rotate away from each other; and when the desktop panel moves down relative to the base, the two movable arms rotate toward each other.

By adopting the above technical solutions, the present disclosure has the following design starting points, concepts and beneficial effects:

A wiring harness can be stored in the wiring harness-accommodating articulated arm assembly. When the desktop panel moves up, the articulated arm assembly limits the height-adjustable desk and can protect the wiring harness from being pulled. When the desktop panel moves down, the articulated arm assembly limits the wiring harness and can prevent the wiring harness from drooping or getting scattered. According to the above solution, by providing the linkage arm, rotating points of the first movable arm and the second movable arm are located at different positions, and the two rotating points are always spaced. This replaces the single hinge point with two hinge points. Meanwhile, the first limiting structure of the linkage arm can limit minimum included angles between the linkage arm and the first and second movable arms, such that the linkage arm and the two movable arms can be folded but cannot be folded into a mutually attached state. Therefore, the clamping region can always have a space that cannot be closed by the movable arm and the linkage arm, and the space can effectively avoid the hand pinching.

### BRIEF DESCRIPTION OF THE DRAWINGS

FIG. 1 is a schematic perspective view showing a wiring harness-accommodating articulated arm assembly according to an embodiment of the present disclosure;

FIG. 2 is a front view showing a wiring harness-accommodating articulated arm assembly according to an embodiment of the present disclosure;

FIG. 3 is a first schematic perspective view showing a height-adjustable desk according to an embodiment of the present disclosure;

FIG. 4 is a second schematic perspective view showing the height-adjustable desk according to an embodiment of the present disclosure;

FIG. 5 is a first exploded view showing a wiring harness-accommodating articulated arm assembly according to an embodiment of the present disclosure;

FIG. 6 is a second exploded view showing the wiring harness-accommodating articulated arm assembly according to an embodiment of the present disclosure;

FIG. 7 is a schematic perspective view showing a linkage arm according to an embodiment of the present disclosure; and

FIG. 8 is a schematic perspective view showing an articulated arm assembly mounted on a base according to an embodiment of the present disclosure.

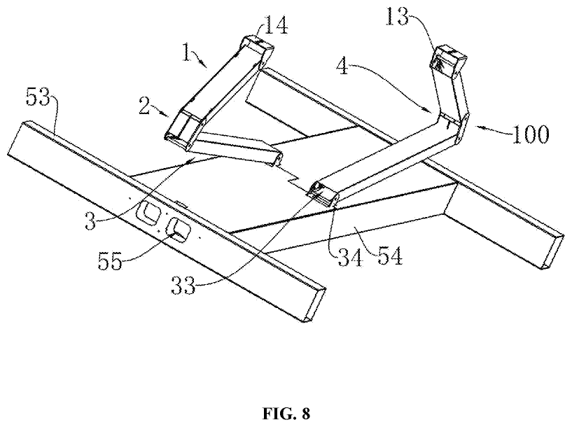

Reference numerals: 100—wiring harness-accommodating articulated arm assembly, 1—first movable arm, 11—first cover plate, 12—first opening, 13—first accommodating space, 14—upper mounting seat, 2—linkage arm, 21—splicing member, 22—baffle, 23—third opening, 24—third accommodating space, 25—first limiting plate, 26—second limiting plate, 3—second movable arm, 31—second cover plate, 32—second opening, 33—second accommodating space, 34—lower mounting seat, 4—clamping region, 51—desktop panel, 52—lifting column, 53—support beam, 54—base, and 55—window.

### DETAILED DESCRIPTION OF THE EMBODIMENTS

Specific implementations of the present disclosure are as follows:

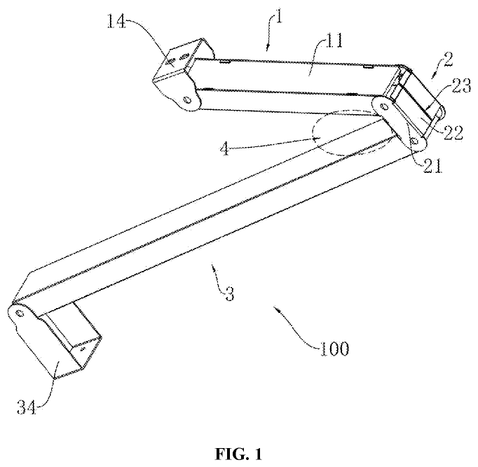

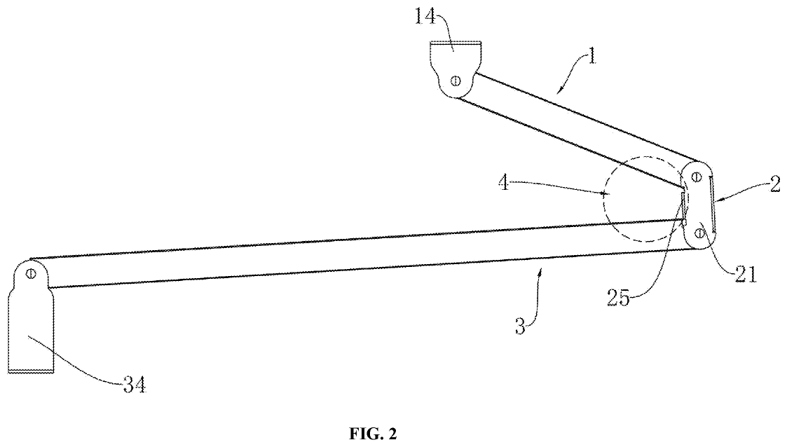

As shown in FIGS. 1 and 2, the present disclosure provides a wiring harness-accommodating articulated arm assembly 100, including a first movable arm 1. The first movable arm 1 is rotatably connected to a linkage arm 2. The linkage arm 2 is rotatably connected to a second movable arm 3. The first movable arm 1 and the second movable arm 3 are respectively rotatably connected to different positions of the linkage arm 2. An included angle is formed between the first movable arm 1 and the second movable arm 3. When the first movable arm 1 and the second movable arm 3 move, the included angle therebetween changes. A clamping region 4 is formed among the first movable arm 1, the linkage arm 2 and the second movable arm 3, and at a position close to the linkage arm 2. A side of the linkage arm 2 close to the clamping region 4 is provided with a first limiting structure. The first limiting structure is configured such that when the first movable arm 1 and the second movable arm 3 rotate toward each other, a spacing between the first movable arm 1 and the second movable arm 3 in the clamping region 4 is always greater than zero.

A wiring harness can be stored in the wiring harness-accommodating articulated arm assembly 100. When a desktop panel 51 moves up, the articulated arm assembly limits the height-adjustable desk and can protect the wiring harness from being pulled. When the desktop panel 51 moves down, the articulated arm assembly limits the wiring harness and can prevent the wiring harness from drooping or getting scattered. According to the above solution, by providing the linkage arm 2, rotating points of the first movable arm 1 and the second movable arm 3 are located at different positions, and the two rotating points are always spaced. This replaces the single hinge point with two hinge points. Meanwhile, the first limiting structure of the linkage arm 2 can limit minimum included angles between the linkage arm 2 and the first and second movable arms, such that the linkage arm 2 and the two movable arms can be folded but cannot be folded into a mutually attached state. Therefore, the clamping region 4 can always have a space that cannot be closed by the movable arm and the linkage arm 2, and the space can effectively avoid the hand pinching.

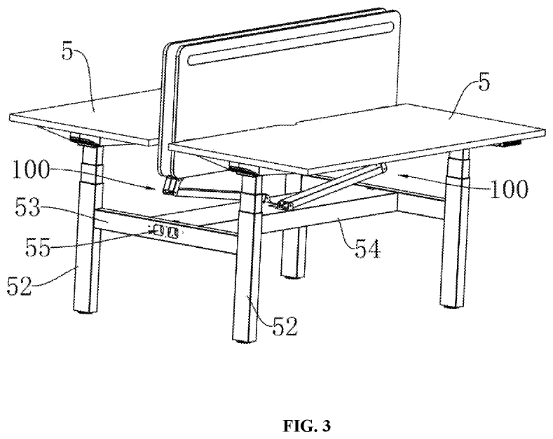

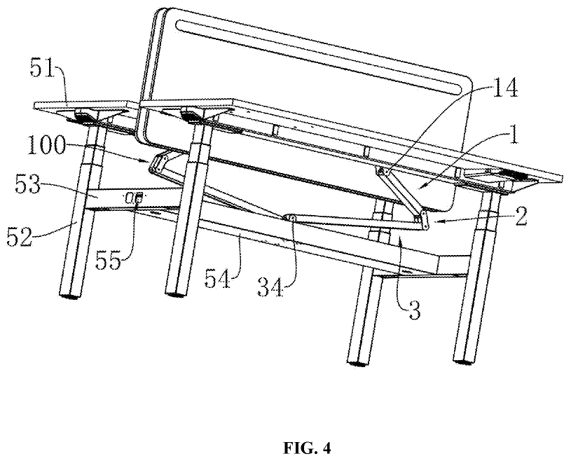

Specifically, as shown in FIGS. 3 and 4, the articulated arm assembly is applied to a height-adjustable desk. The height-adjustable desk is a two-person height-adjustable desk, and includes two desktop panels 51. Two lifting columns 52 are connected under each desktop panel 51. A support beam 53 is mounted between lifting columns 52 on a same side and under different desktop panels 51. A base 54 is disposed between the two support beams 53. One articulated arm assembly is disposed between the base 54 and each of the two desktop panels 51. The two movable arms of the articulated arm assembly are respectively rotatably connected to the desktop panel 51 and the base 54. When the desktop panel 51 moves up relative to the base 54, the two movable arms rotate away from each other. When the desktop panel 51 moves down relative to the base 54, the two movable arms rotate toward each other. As the desktop panel 51 moves up and down, the articulated arm assembly opens (unfolds) or closes (folds) to adapt to a lifting motion of the height-adjustable desk, and protects the wiring harness.

The first movable arm 1, the second movable arm 3, and the linkage arm 2 are all hollow. The first movable arm 1 is provided with a first accommodating space 13. The second movable arm 3 is provided with a second accommodating space 33. The linkage arm 2 is provided with a third accommodating space 24. The first movable arm 1 is located above the second movable arm 3. The linkage arm 2 is located between the first movable arm 1 and the second movable arm 3. The first accommodating space 13 communicates with the second accommodating space 33 via the third accommodating space 24, allowing the wiring harness to smoothly enter the articulated arm assembly, pass through the articulated arm assembly, and exit from the articulated arm assembly. Both the first movable arm 1 and the second movable arm 3 are U-shaped long tubes and each is equipped with a detachable cover plate. The linkage arm 2 includes two splicing members 21 that are spaced apart. Two ends of each splicing member 21 are respectively rotatably connected to sides of two U-shaped long tubes. A length of the linkage arm 2 is much less than lengths of the two movable arms. Specifically, the length of the linkage arm 2 is less than 32% of the length of the first movable arm 1, and the length of the linkage arm 2 is less than 13% of the length of the second movable arm 3. In the articulated arm assembly, the two movable arms mainly function to accommodate the wiring harness and move with the desktop panel 51, and the linkage arm 2 mainly functions to link and limit the two movable arms.

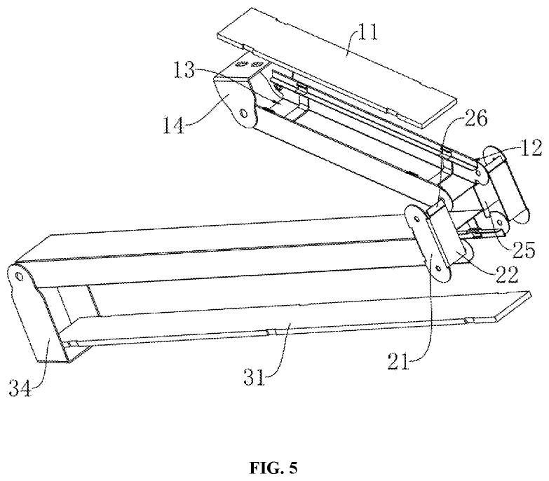

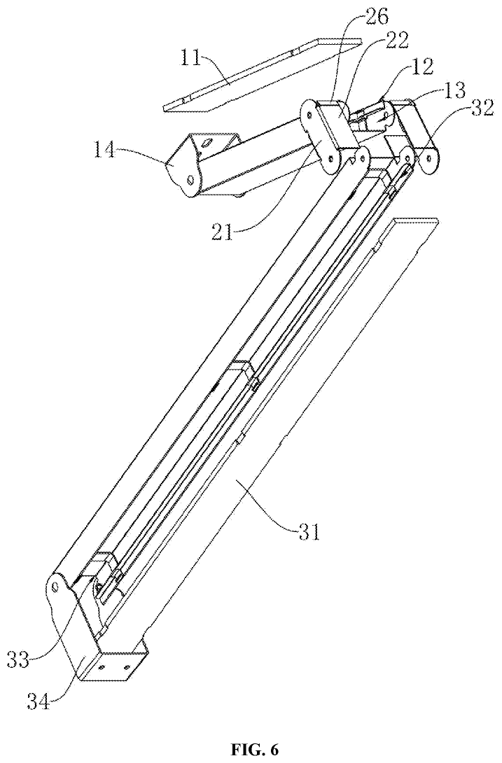

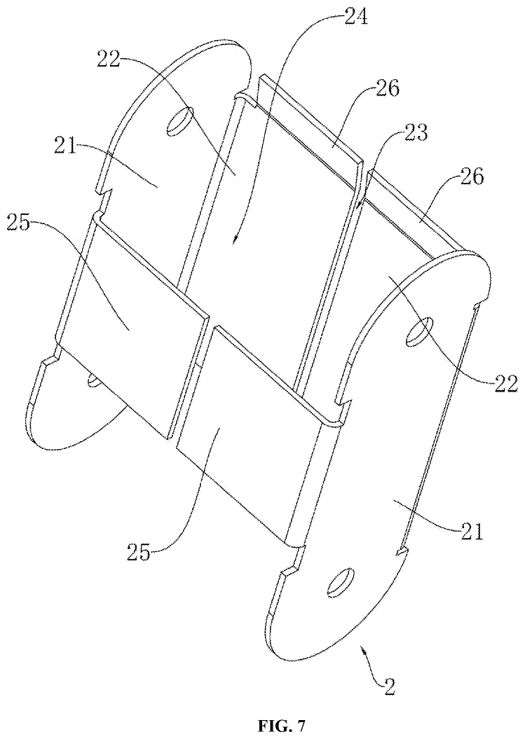

Specifically, as shown in FIGS. 5 to 7, the first movable arm 1 includes a first cover plate 11 that is detachably connected. When the first cover plate 11 is detached, a first opening 12 distributed along a length direction of the first movable arm 1 is formed in the first movable arm 1. The first opening 12 is configured to allow the wiring harness to enter the first accommodating space 13 from the first opening 12. The first cover plate 11 is configured to seal the first opening 12 to limit the wiring harness in the first accommodating space 13. Similarly, the second movable arm 3 includes a second cover plate 31 that is detachably connected. When the second cover plate 31 is detached, a second opening 32 distributed along a length direction of the second movable arm 3 is formed in the second movable arm 3. The second opening 32 is configured to allow the wiring harness to enter the second accommodating space 33 from the second opening 32. The second cover plate 31 is configured to seal the second opening 32 to limit the wiring harness in the second accommodating space 33. The wiring harness includes one end connected to an electrical appliance, and another end being a plug to be inserted into a power supply. A size of the plug is much greater than a diameter of the wiring harness. When the wiring harness is mounted into the articulated arm assembly, inserting the plug into the articulated arm assembly is unreasonable, because this approach requires an oversized diameter of the tube to increase the material cost. By contrast, inserting the wiring harness is more preferable. To directly insert the wiring harness, a sufficiently long opening needs to be provided. After the wiring harness is mounted, the opening is sealed by the cover plate to limit the wiring harness in the tube.

The linkage arm has two baffles. A gap is formed between the two baffles. Specifically, the linkage arm 2 includes two splicing members 21 that are spaced apart. Two ends of each splicing member 21 are respectively rotatably connected to a side of the first movable arm 1 and a side of the second movable arm 3. The splicing member 21 includes a baffle 22 away from the clamping region 4. After the two splicing members 21 are mounted onto the movable arms, a gap is formed between the two baffles 22. The gap forms a third opening 23. The third opening 23 is configured to allow the wiring harness to enter the third accommodating space 24 from the third opening 23. The two baffles 22 are configured to limit the wiring harness in the third accommodating space 24. The linkage arm 2 is divided into two identical splicing members 21, which can lower the production cost, and reduce the assembly difficulty. First, the length of the linkage arm 2 is much less than the lengths of the two movable arms. Since the linkage arm 2 serves as an intermediate linkage member for the two movable arms, and is hinged to the two movable arms 2, the opening arrangement of the linkage arm 2 differs from that of the movable arm for better reasonability. The third opening 23 is merely the gap between the two baffles 22. Since the wiring harness itself is small in size, the third opening 23 is sufficient for the wiring harness to pass therethrough into the third accommodating space 24. Meanwhile, the baffles 22 can further prevent the wiring harness from slipping out of the third accommodating space 24.

Furthermore, the first limiting structure is plate-like and serves as a first limiting plate 25. Each splicing member 21 is provided with one first limiting plate 25. The first limiting plate 25 is located on an opposite side of the baffle 22. The first limiting plate 25 is configured such that when the first movable arm 1 or the second movable arm 3 moves to abut against the first limiting plate 25, the first limiting plate 25 prevents the movable arm from continuously rotating. The first limiting structure features a simple component configuration and constitutes a part of the linkage arm 2. It is noted that the size of the first limiting plate 25 should match a lifting stroke of the height-adjustable desk. An excessively long limiting plate will result in insufficient folding of the articulated arm assembly, causing obstruction to downward movement of the desktop panel 51 and even damage to the articulated arm assembly. An excessively short limiting plate cannot achieve a favorable limiting effect. It is desirable that the two movable arms are always stably folded and unfolded in a same direction. When the included angle between the first movable arm 1 and the second movable arm 3 is controlled within 180°, reverse folding or unfolding of the first movable arm 1 and the second movable arm 3 can be avoided. Reverse folding or unfolding has unpredictability and may cause injury to users. Accordingly, with the first limiting plate 25, the included angle between the first movable arm 1 and the second movable arm 3 is always less than 180°.

A side of the linkage arm 2 facing away from the clamping region 4 is provided with a second limiting structure. The second limiting structure is configured such that the first movable arm 1 and the second movable arm 3 are always located on one side of the linkage arm 2. In other words, the clamping region 4 is always located on one side of the linkage arm 2. Specifically, when the first movable arm 1 and the second movable arm 3 rotate away from each other, the included angle between the first movable arm 1 and the second movable arm 3 is less than 180°.

Specifically, the second limiting structure is plate-like and serves as a second limiting plate 26. The second limiting plate 26 is disposed on each of the two splicing members 21. The second limiting plate 26 is disposed on an upper end of the baffle 22. The second limiting plate 26 obliquely extends toward the clamping region 4. The second limiting plate 26 is configured such that when the first movable arm 1 moves to abut against the second limiting plate 26, the second limiting plate 26 prevents the movable arm from continuously rotating. Similarly, the second limiting plate 26 features a simple structure and constitutes a part of the linkage arm. The first limiting plate 25 limits a closing angle of the two movable arms, while the inclined second limiting plate 26 limits an opening angle of the two movable arms.

As shown in FIGS. 2, 3, and 7, an upper mounting seat 14 is hinged to an upper end of the first movable arm 1. The upper mounting seat 14 is mounted on a lower surface of the desktop panel 51. A lower mounting seat 34 is hinged to a lower end of the second movable arm 3. The base 54 is hollow. The lower mounting seat 34 is mounted in the base 54 and protrudes upward from an upper surface of the base 54 to be hinged to the second movable arm 3. Both upper and lower ends of the first movable arm 1 and the second movable arm 3 are open. Windows 55 are respectively formed in a side of the base 54 and a side of the support beam 53, such that the plug of the wiring harness can exit the height-adjustable desk for connection to the power supply.

As the desktop panel 51 moves up and down, the included angle between the first movable arm 1 and the second movable arm 3 changes. When the desktop panel 51 moves up to a highest position, the included angle between the first movable arm 1 and the second movable arm 3 is maximum, which corresponds to an unfolded or open state. When the desktop panel 51 moves down to a lowest position, the included angle between the first movable arm 1 and the second movable arm 3 is minimum, which corresponds to a folded or closed state. As the included angle changes, there is no fixed movement sequence between the movable arms and the linkage arm 2. That is, the first movable arm 1 may rotate relative to the linkage arm 2, or the second movable arm 3 may rotate relative to the linkage arm 2, or the two movable arms may rotate relative to the linkage arm 2. Nevertheless, the first and second limiting structures on the linkage arm 2 define the maximum included angle and the minimum included angle for the articulated arm assembly, so as to ensure the normal movement and anti-pinch effect of the articulated arm assembly.

In the wiring harness-accommodating articulated arm assembly 100, the single linkage arm 2 may also be replaced by a chain joint (this solution is not shown in the figures). Specifically, the chain joint is hinged between the two movable arms. The two movable arms are hinged to different positions of the chain joint. An included angle is formed between the two movable arms. The included angle changes as the two movable arms move. A clamping region 4 is formed among the two movable arms and the chain joint and at a position close to the chain joint. A side of the chain joint facing toward the clamping region 4 is provided with a first limiting structure. The first limiting structure is configured such that when the two movable arms rotate toward each other, a spacing between the two movable arms in the clamping region 4 is always greater than zero. In this solution, the two movable arms are hinged via the chain joint. The chain joint can be regarded as an assembly formed by hinging at least two linkage arms 2 together. While the first limiting structure is provided, the clamping region 4 is not completely closed or eliminated when the chain joint is folded or closed, thereby preventing hand pinching in the clamping region 4. The first limiting structure acts on the two movable arms and also avoids hand pinching due to a fact that the two movable arms are folded into attachment.

There may be two or more chain joints. Each chain joint includes two linkage arms 2 that are rotatably disposed opposite to each other. The two linkage arms 2 are disposed between the two movable arms. The two movable arms are respectively hinged to the two linkage arms 2. The two linkage arms 2 are directly hinged to each other, thereby forming a two-section chain structure. Alternatively, at least one connecting arm is hinged between the two linkage arms 2. The two linkage arms 2 are hinged to different positions of the connecting arm. The connecting arm is equivalent to the linkage arm 2 that is configured to connect the two linkage arms 2, and has a same structure as the linkage arm 2. This forms a chain structure including at least three sections.

The first limiting structure is also disposed on the connecting arm. A second limiting structure is further disposed on each of the connecting arm and the linkage arm 2. The second limiting structure is plate-like and serves as the second limiting plate 26. The second limiting plate 26 obliquely extends toward the clamping region 4. The second limiting plate 26 is configured such that when the two movable arms rotate away from each other, the included angle between the two movable arms is always less than 180°.

As shown in FIGS. 3 and 4, this embodiment provides an application example of the wiring harness-accommodating articulated arm assembly. The wiring harness-accommodating articulated arm assembly is applied to a height-adjustable desk, and specifically to a two-person height-adjustable desk including two desktop panels 51. Two lifting columns 52 are connected under each desktop panel 51. A support beam 53 is mounted between lifting columns 52 on a same side and under different desktop panels 51. A base 54 is disposed between two support beams 53. One articulated arm assembly 100 is disposed between the base 54 and each of the two desktop panels 51. The two movable arms of the articulated arm assembly 100 are respectively rotatably connected to the desktop panel 51 and the base 54. When the desktop panel 51 moves up relative to the base 54, the two movable arms rotate away from each other. When the desktop panel 51 moves down relative to the base 54, the two movable arms rotate toward each other. As the desktop panel 51 moves up and down, the articulated arm assembly 100 opens (unfolds) or closes (folds), adapting to a lifting motion of the height-adjustable desk, and protecting the wiring harness.

What is claimed is:

1. A wiring harness-accommodating articulated arm assembly, comprising: a first movable arm, a linkage arm; and a second movable arm; wherein the first movable arm and the second movable arm are respectively rotatably connected to different positions of the linkage arm; an included angle is formed between the first movable arm and the second movable arm; when the first movable arm and the second movable arm move, the included angle between the first movable arm and the second movable arm changes; a clamping region is formed among the first movable arm, the linkage arm and the second movable arm, and at a position close to the linkage arm; a side of the linkage arm facing toward the clamping region is provided with a first limiting structure; and the first limiting structure is configured such that when the first movable arm and the second movable arm rotate toward each other, a spacing between the first movable arm and the second movable arm in the clamping region is always greater than zero.

2. The wiring harness-accommodating articulated arm assembly according to claim 1, wherein the first movable arm, the second movable arm, and the linkage arm are all hollow; the first movable arm is provided with a first accommodating space; the second movable arm is provided with a second accommodating space; and the linkage arm is provided with a third accommodating space.

3. The wiring harness-accommodating articulated arm assembly according to claim 2, wherein the first movable arm comprises a first cover plate that is detachably connected; when the first cover plate is detached, a first opening distributed along a length direction of the first movable arm is formed in the first movable arm; the first opening is configured to allow a wiring harness to enter the first accommodating space from the first opening; and the first cover plate is configured to seal the first opening to limit the wiring harness in the first accommodating space.

4. The wiring harness-accommodating articulated arm assembly according to claim 2, wherein the second movable arm comprises a second cover plate that is detachably connected; when the second cover plate is detached, a second opening distributed along a length direction of the second movable arm is formed in the second movable arm; the second opening is configured to allow a wiring harness to enter the second accommodating space from the second opening; and the second cover plate is configured to seal the second opening to limit the wiring harness in the second accommodating space.

5. The wiring harness-accommodating articulated arm assembly according to claim 2, wherein the linkage arm has two baffles; a gap is formed between the two baffles; the gap forms a third opening; the third opening is configured to allow a wiring harness to enter the third accommodating space from the third opening; and the two baffles are configured to limit the wiring harness in the third accommodating space.

6. The wiring harness-accommodating articulated arm assembly according to claim 5, wherein the linkage arm comprises two splicing members that are spaced apart; two ends of each of the two splicing members are respectively rotatably connected to a side of the first movable arm and a side of the second movable arm; and the two baffles are respectively formed on the two splicing members.

7. The wiring harness-accommodating articulated arm assembly according to claim 1, wherein the first limiting structure is plate-like and serves as a first limiting plate; and the first limiting plate is configured such that when the first movable arm or the second movable arm moves to abut against the first limiting plate, the first limiting plate prevents the movable arm from continuously rotating.

8. The wiring harness-accommodating articulated arm assembly according to claim 1, wherein the included angle between the first movable arm and the second movable arm is always less than 180°.

9. The wiring harness-accommodating articulated arm assembly according to claim 8, wherein a side of the linkage arm facing away from the clamping region is provided with a second limiting structure; and the second limiting structure is configured such that the first movable arm and the second movable arm are always located on one side of the linkage arm.

10. The wiring harness-accommodating articulated arm assembly according to claim 9, wherein the second limiting structure is plate-like and serves as a second limiting plate; the second limiting plate obliquely extends toward the clamping region; and the second limiting plate is configured such that when the first movable arm or the second movable arm moves to abut against the second limiting plate, the second limiting plate prevents the movable arm from continuously rotating.

11. A wiring harness-accommodating articulated arm assembly, comprising: two movable arms, wherein a chain joint is hinged between the two movable arms; the two movable arms are hinged to different positions of the chain joint; an included angle is formed between the two movable arms; the included angle changes as the two movable arms move; a clamping region is formed among the two movable arms and the chain joint and at a position close to the chain joint; a side of the chain joint facing toward the clamping region is provided with a first limiting structure; and the first limiting structure is configured such that when the two movable arms rotate toward each other, a spacing between the two movable arms in the clamping region is always greater than zero.

12. The wiring harness-accommodating articulated arm assembly according to claim 11, wherein the chain joint comprises two linkage arms that are rotatably disposed opposite to each other; the two linkage arms are disposed between the two movable arms; and the two movable arms are respectively hinged to the two linkage arms.

13. The wiring harness-accommodating articulated arm assembly according to claim 12, wherein the two linkage arms are directly hinged to each other.

14. The wiring harness-accommodating articulated arm assembly according to claim 12, wherein at least one connecting arm is hinged between the two linkage arms; and the two linkage arms are hinged to different positions of the connecting arm.

15. The wiring harness-accommodating articulated arm assembly according to claim 14, wherein the first limiting structure is also disposed on the connecting arm; a second limiting structure is further disposed on each of the connecting arm and the linkage arm; the second limiting structure is plate-like and serves as a second limiting plate; the second limiting plate obliquely extends toward the clamping region; and the second limiting plate is configured such that when the two movable arms rotate away from each other, the included angle between the two movable arms is always less than 180°.
